(19) United States
(12) Patent Application Publication
(10) Pub. No.: US 2026/0045604 A1
(43) Pub. Date: Feb. 12, 2026

(54) PACKAGING MATERIAL FOR POWER STORAGE DEVICES

(71) Applicant: DNP HIGH-PERFORMANCE MATERIALS HIKONE CO., LTD., Hikone-shi (JP)

(72) Inventor: Kenji YOSHINO, Hikone-shi (JP)

(73) Assignee: DNP HIGH-PERFORMANCE MATERIALS HIKONE CO., LTD., Hikone-shi (JP)

(21) Appl. No.: 19/361,023

(22) Filed: Oct. 17, 2025

Related U.S. Application Data
(63) Continuation of application No. PCT/JP2024/015166, filed on Apr. 16, 2024.

(30) Foreign Application Priority Data
Apr. 17, 2023 (JP) 2023-067332

(51) Int. Cl. H01M 50/133; H01M 10/0525; H01M 50/119; H01M 50/121; H01M 50/126

(52) U.S. Cl. CPC H01M 50/133; H01M 50/119; H01M 50/121; H01M 50/126; H01M 10/0525

(57) ABSTRACT

A packaging material for power storage devices is disclosed. It includes a metal foil layer, a resin base layer on the outer surface, and a thermoplastic heat-fusible layer on the inner surface. The heat-fusible layer has an innermost seal layer containing mixed particles of at least two types with different volume-based median particle diameters (D50) measured by laser diffraction. In the cumulative distribution, D10 is 2 μm or less and D90 is 6 μm or more. In the particle size distribution, only one peak is present within D10-D90, and the peak value appears at a particle diameter range of 1 μm to 10 μm, thereby providing stable and excellent formability.

### CROSS-REFERENCE TO RELATED APPLICATIONS

The present application is a continuation application of International Application No. PCT/JP2024/015166, filed on Apr. 16, 2024, which claims priority to Japanese Patent Application No. 2023-067332 filed on Apr. 17, 2023, the contents of which are incorporated herein by reference in its entirety.

### BACKGROUND OF THE INVENTION

### Field of the Invention

The present disclosure relates to a packaging material for power storage devices, such as batteries and capacitors used in mobile devices including smartphones and tablet terminals, as well as batteries and capacitors used for power storage in hybrid vehicles, electric vehicles, wind power generation, solar power generation, and used for storing electricity generated at nighttime.

### Description of the Related Art

In recent years, as mobile devices such as smartphones and tablet terminals have become thinner and lighter, laminated structures composed of a heat-resistant resin layer (base layer), an adhesive layer, a metal foil layer (barrier layer), another adhesive layer, and a thermoplastic resin layer (heat-fusible layer) have been used as packaging materials for power storage devices such as lithium-ion secondary batteries, lithium polymer secondary batteries, lithium-ion capacitors, and electric double-layer capacitors installed in such devices, in place of conventional metal cans.

In addition, there is a growing trend toward using the laminated structures (packaging materials) with the above configuration for applications such as power supplies for electric vehicles, large-scale power supplies for power storage, and capacitors. To form a packaging material for power storage devices, cold forming, such as stretch forming or deep drawing, is performed on the laminate to shape it into a three-dimensional form, for example, a substantially rectangular box shape. By forming such a three-dimensional shape, a housing space for accommodating the main body of the power storage device can be secured. Therefore, to secure a highly precise housing space, it is preferable to improve the formability.

For example, the packaging material for power storage devices disclosed in Patent Document 1 ensures good formability by improving sliding properties through the addition of a lubricant to the exposed surface of the inner layer (heat-seal layer).

Also, the packaging material for power storage devices disclosed in Patent Document 2 ensures good formability by appropriately adjusting the arithmetical mean height (Ra), either by causing phase separation in the exposed surface of the heat-fusible layer or by adding small particles to the exposed surface layer.

### PRIOR ART DOCUMENTS

### Patent Documents

Patent Document 1: Japanese Patent No. 3774163
Patent Document 2: Japanese Patent No. 5380762

### SUMMARY OF THE INVENTION

### Problems to be Solved by the Invention

However, in the conventional packaging material for power storage devices disclosed in Patent Document 1, the exposed surface layer to which the lubricant is added is susceptible to transfer. Therefore, the amount of lubricant present may vary during use, resulting in variations in sliding properties and making it impossible to achieve stable formability. Furthermore, in areas such as corners of the formed portion where the forming angle is nearly at a right angle, delamination is likely to occur, which also prevents favorable formability from being achieved.

In the conventional packaging material for power storage devices disclosed in Patent Document 2, it is necessary to provide irregularities over a wide area of the exposed surface. However, merely adjusting the arithmetical mean height (Ra) improves sliding properties only partially, and uniform sliding properties over the entire area cannot be achieved, making it impossible to obtain stable and favorable formability.

Preferred embodiments of the present disclosure have been made in view of the above-described and/or other problems in the prior art. Such embodiments are capable of significantly improving conventional methods and/or devices.

The present disclosure has been made in view of the above problems, and an object thereof is to provide a packaging material for power storage devices capable of achieving stable and good formability.

Other objects and advantages of the present disclosure will become apparent from the following preferred embodiments.

### Means for Solving the Problems

In order to solve the above problems, the present disclosure provides the following means.

[1] A packaging material for power storage devices, the packaging material comprising:
a metal foil layer having an outer surface side and an inner surface side opposite to the outer surface side;
a base layer made of resin and provided on the outer surface side of the metal foil layer; and
a heat-fusible layer made of thermoplastic resin and provided on the inner surface side of the metal foil layer, the heat-fusible layer comprising: a seal layer provided to form an innermost side of the packaging material, the seal layer including mixed particles of two or more types of particles having different volume-based median particle diameters, defined as D50, which is a particle diameter at 50% of a cumulative distribution in a particle size distribution measurement by a laser diffraction scattering method,
wherein, in the cumulative distribution of the mixed particles, D10, which is a particle diameter at 10% of the cumulative distribution counted from a smaller particle diameter side, is 2 μm or less, and D90, which is a particle diameter at 90% of the cumulative distribution counted from a smaller particle diameter side, is 6 μm or more,
wherein in a particle size distribution of the mixed particles, only one peak is present within a range of D10 to D90, and
wherein a peak value in the particle size distribution of the mixed particles is present in a particle diameter range of 1 μm to 10 μm.

[2] The packaging material for power storage devices as recited in the above-described Item [1],
wherein the mixed particles include small particles, medium particles, and large particles, which are immiscible particles belonging to three distributions having different volume-based median particle diameters,
wherein the small particles have a volume-based median particle diameter of 0.05 μm to 5 μm,
wherein the medium particles have a volume-based median particle diameter of 3 μm to 8 μm, and
wherein the large particles have a volume-based median particle diameter of 7 μm to 15 μm.

[3] The packaging material for power storage devices as recited in the above-described Item [1] or [2],
wherein the seal layer has a content of the mixed particles by weight in a range of 3,000 ppm to 20,000 ppm.

[4] The packaging material for power storage devices as recited in any one of the above-described Items [1] to [3],
wherein the seal layer has a thickness of 5 μm or more.

[5] The packaging material for power storage devices as recited in any one of the above-described Items [1] to [4],
wherein the mixed particles have an aspect ratio of 0.2 to 1.

[6] The packaging material for power storage devices as recited in any one of the above-described Items [1] to [5],
wherein the seal layer contains a lubricant.

[7] The packaging material for power storage devices as recited in any one of the above-described Items [1] to [6],
wherein a relational expression (D90-D10)/D50=0.5 to 5 is satisfied.

[8] A film used for the heat-fusible layer in the packaging material for power storage devices as recited in any one of the above-described Items [1] to [7],
wherein a portion corresponding to the seal layer is composed of a resin layer containing the mixed particles.

[9] A method for manufacturing a film used for the heat-fusible layer in the packaging material for power storage devices as recited in any one of the above-described Items [1] to [7],
wherein a portion corresponding to the seal layer is formed of a resin layer blended with the mixed particles.

[10] A power storage device comprising:
a power storage device main body; and
the packaging material for power storage devices as recited in any one of the above-described Items [1] to [7],
wherein the power storage device main body is enclosed with the packaging material.

### Effects of the Invention

According to Invention [1], the packaging material for power storage devices includes a seal layer on the inner surface side of the heat-fusible layer that contains mixed particles having different particle diameters, so that projections of various sizes can be formed. Furthermore, because the mixed particles are measured to have a single peak within a defined particle size distribution width in the particle size distribution measurement results, aggregation of the mixed particles is less likely to occur. As a result, the particles can be uniformly dispersed to form projections on the inner surface of the heat-fusible layer. This reduces the contact area with a molding die or other forming tool during forming, improves sliding properties, and enables stable and favorable formability.

According to Invention [2], the packaging material for power storage devices contains, in the seal layer, small, medium, and large particles having specified particle diameters, which makes it easier to blend mixed particles having a desired particle size distribution. As a result, intended irregularities can be formed on the inner surface of the heat-fusible layer, thereby further reducing the contact area with a molding tool during forming and further improving the formability.

According to Invention [3], in the packaging material for power storage devices, the content of the mixed particles in the seal layer is specified, so that the mixed particles can be appropriately dispersed and evenly distributed within the seal layer. As a result, desired irregularities can be formed on the inner surface of the heat-fusible layer, thereby further improving the formability.

According to Invention [4], in the packaging material for power storage devices, the thickness of the seal layer is specified, so that the mixed particles can be stably and securely fixed within the seal layer. This prevents issues such as detachment of the mixed particles, thereby further reliably improving formability.

According to Invention [5], in the packaging material for power storage devices, the aspect ratio of the mixed particles is specified, so that projections can be sufficiently formed regardless of their orientation, and detachment is less likely to occur, thereby further improving formability.

According to Invention [6], since the seal layer contains a lubricant, the lubricant exudes and appears on the inner surface of the heat-fusible layer at a certain temperature or higher, thereby further improving sliding properties and enhancing formability.

According to Invention [7], since the relational expression (D90−D10)/D50=0.5 to 5 is satisfied, the volume distribution of the mixed particles can more reliably exhibit a broad distribution, thereby further improving formability during molding.

According to Invention [8], the film for the heat-fusible layer in the packaging material for power storage devices enables reliable manufacture of the above packaging material with the film.

According to Invention [9], the method for manufacturing a film for the heat-fusible layer in the packaging material for power storage devices enables reliable manufacture of the above packaging material.

According to Invention [10], since the power storage device comprises the above packaging material having excellent sliding properties against a molding jig, it can provide a high-quality power storage device with superior operational reliability.

### BRIEF DESCRIPTION OF THE DRAWINGS

Some embodiments of the present disclosure are shown by way of example, and not limitation, in the accompanying figures.

FIG. 1 is a cross-sectional view showing a packaging material for power storage devices according to an embodiment of the present disclosure.

FIG. 2 is a schematic cross-sectional view illustrating the heat-fusible layer of the packaging material for power storage devices according to an embodiment.

FIG. 3 is a graph showing particle size distributions of individual particles and of mixed particles according to an embodiment.

FIG. 4 is a graph showing the particle size distribution and the cumulative distribution of the mixed particles in an embodiment.

FIG. 5 is a graph illustrating the peak value in the particle size distribution of the mixed particles in an embodiment.

FIG. 6 is a schematic cross-sectional view illustrating the seal layer in the heat-fusible layer, where a lubricant is precipitated.

FIG. 7 is a cross-sectional view showing a power storage device manufactured using the packaging material of an embodiment.

FIG. 8 is an exploded perspective view of the power storage device of an embodiment.

### EMBODIMENTS FOR CARRYING OUT THE INVENTION

In the following paragraphs, some embodiments in the present disclosure will be described by way of example and not limitation. It should be understood based on this disclosure that various other modifications can be made by those in the art based on these illustrated embodiments.

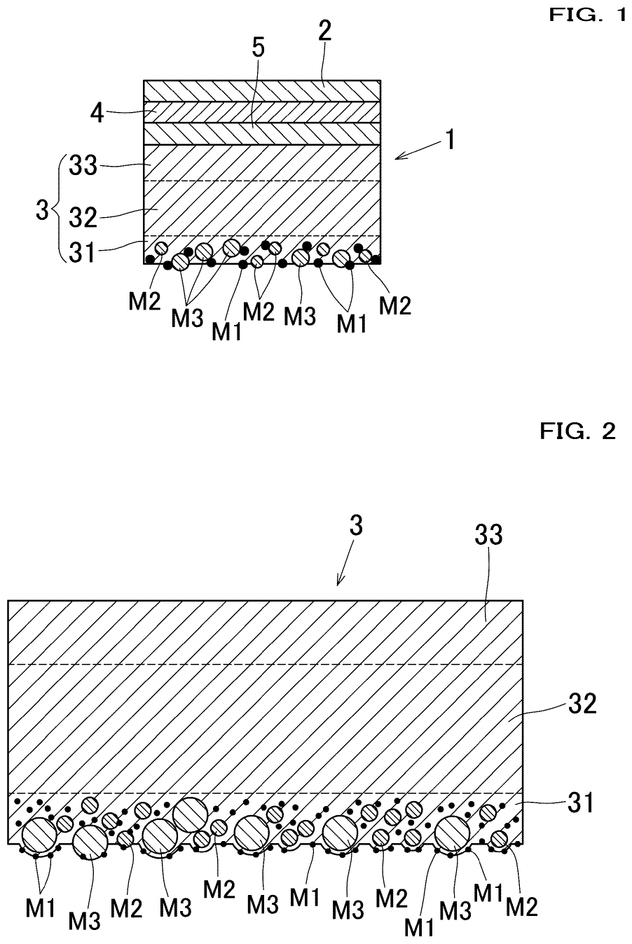

FIG. 1 is a cross-sectional view showing a packaging material for power storage devices according to an embodiment of the present disclosure. As shown in FIG. 1, the packaging material 1 for power storage devices includes: a metal foil layer 4 consisting of a metal foil; a base layer 2 made of heat-resistant resin, provided on the outer surface side of the metal foil layer 4 and serving as an outer layer; an adhesive layer 5 provided on the inner surface side of the metal foil layer 4; and a heat-fusible layer (sealant layer) 3 made of heat-fusible resin, provided on the inner surface side of the adhesive layer 5 and serving as an inner layer.

In this specification, when describing the positions of the respective layers constituting the packaging material for batteries in terms of direction (the upward direction in FIG. 1), the direction toward the base layer 2 is referred to as the outer side, while the direction toward the heat-fusible layer 3 (the downward direction in FIG. 1) is referred to as the inner side.

The base layer 2 is preferably formed using polyamide-based resin, polyester-based resin, polyolefin-based resin, polyimide-based resin, or the like. The base layer 2 can be formed either by coating or by using a film. The base layer 2 is preferably formed using a biaxially stretched film of the above-mentioned resin, and more preferably using a biaxially stretched polyamide film or a biaxially stretched polyester film. Among these, examples of biaxially stretched polyamide films that can be suitably used, although not particularly limited, include biaxially stretched 6 nylon film, biaxially stretched 6,6 nylon film, and biaxially stretched MXD nylon film. Examples of polyester films that can be suitably used include a biaxially stretched polybutylene terephthalate (PBT) film, a biaxially stretched polyethylene terephthalate (PET) film, and a biaxially stretched polyethylene naphthalate (PEN) film.

As the heat-resistant resin constituting the base layer 2, it is preferable to use a thermoplastic resin having a melting point higher by 10° C. or more than that of the heat-fusible resin constituting the heat-fusible layer 3, and more preferably a thermoplastic resin having a melting point higher by 20° C. or more. The thickness of the base layer 2 is preferably set to 9 μm to 50 μm.

The metal foil layer 4 may suitably be formed of a single metal foil, such as an aluminum (Al) foil, a copper (Cu) foil, a stainless steel (SUS) foil, a titanium (Ti) foil, or a nickel (Ni) foil, or a clad material in which two or more of these metal foils are laminated. The thickness of the metal foil layer 4 is preferably set to 20 μm to 150 μm. That is, if the thickness is too small, durability may be reduced due to the occurrence of pinholes or the like, while if the thickness is too large, the formability may be impaired.

It is preferable to form a primer layer on at least one of the inner surface and the outer surface of the metal foil layer 4, particularly on the surface on the side of the heat-fusible layer 3 (the inner surface).

The primer layer can be formed by performing a chemical conversion treatment such as an application treatment of a silane coupling agent or a chromate treatment. The thickness of the primer layer is preferably set to 0.01 μm to 1 μm.

By forming the primer layer in this manner, it is possible to improve the corrosion resistance of the metal foil layer 4 and also to enhance the adhesive strength with the adhesive layer 5 provided on the inner surface, thereby effectively preventing peeling of the adhesive layer 5.

When forming the primer layer with a coating (i.e., a chemical conversion coating) by chemical conversion, the coating may be selected in view of its compatibility with the adhesive layer 5. Examples of suitable coatings include those formed by chromic acid treatment, phosphochromate treatment, zinc phosphate treatment, non-chromate treatment using zirconium or titanium as a Cr substitute, and an oxide coating formed by boehmite treatment.

The base layer 2 is adhered to the outer surface of the metal foil layer 4 with an adhesive, as necessary, and thereby integrally laminated.

As the adhesive for bonding the base layer 2 and the metal foil layer 4, and as the adhesive between films when forming the base layer 2 with multiple films, an adhesive layer formed using a two-part curable adhesive can be suitably employed. For example, such a two-part curable adhesive may be composed of a first liquid (main agent) containing one or more polyols selected from the group consisting of a polyurethane-based polyol, a polyester-based polyol, a polyether-based polyol, or a polyester urethane-based polyol, and a second liquid (curing agent) consisting of isocyanate. The thickness of the adhesive layer is preferably set to 2 μm to 5 μm.

As the adhesive layer 5 provided on the inner surface of the metal foil layer 4, an adhesive containing one or more resins selected from the group consisting of polyurethane-based resin, acrylic-based resin, epoxy-based resin, polyolefin-based resin, elastomer-based resin, fluorine-based resin, and acid-modified polypropylene resin can be suitably used. Particularly preferably, the adhesive is a polyurethane composite resin based on acid-modified polyolefin. The thickness of the adhesive layer 5 is preferably set to 2 μm to 5 μm.

The adhesive layer 5 may alternatively be formed by heat lamination using a modified polyolefin (e.g., acid-modified polypropylene). In this case, the thickness is preferably 10 μm to 30 μm.

Examples of thermoplastic resins constituting the heat-fusible layer 3 include polyethylene-based resin such as LDPE (low-density polyethylene), LLDPE (linear low-density polyethylene), HDPE (high-density polyethylene), and polyethylene-based copolymer; polypropylene-based resin such as rPP (random polypropylene), bPP (block polypropylene), hPP (homopolypropylene), and polypropylene-based copolymer; polybutene-based copolymers; and ionomer. Particularly preferably, polypropylene-based resin is used because of its resistance to electrolyte, water, and oxygen permeability. From the viewpoint of handling, the thermoplastic resin is preferably in the form of a film, and particularly preferably, a non-stretched polypropylene film such as CPP (cast polypropylene) or IPP (inflation polypropylene) is used.

FIG. 2 is a cross-sectional view showing the heat-fusible layer 3 in the packaging material 1 according to this embodiment. As shown in FIGS. 1 and 2, in this embodiment, the heat-fusible layer 3 is formed of a three-layer laminate comprising a seal layer 31 disposed on the innermost side, an outer layer 33 disposed on the outermost side, which is also referred to as a metal foil side layer or a laminate layer, and an intermediate layer 32 disposed between the seal layer 31 and the outer layer 33.

In the present disclosure, the heat-fusible layer 3 is not limited to three layers, and may be formed of a single layer, two layers, or four or more layers. However, in the present disclosure, when the heat-fusible layer 3 has a laminated structure, a multilayer structure facilitates the formation of a desired laminated structure.

In the present disclosure, it is not always necessary to use different resins for each layer. For example, the seal layer 31, the intermediate layer 32, and the outer layer 33 may be formed of the same type of resin, such that the resin of the innermost layer to which mixed particles are added and the resin of the adjacent layer without mixed particles are of the same type.

As described above, the film for the heat-fusible layer 3 may be a single layer or a multilayer, but in view of heat sealability, delamination resistance, and insulation properties, it is preferably formed using a multilayer film such as a co-extruded product. For example, in this embodiment, a three-layer co-extruded CPP film in which rPP layers are disposed on both sides of an hPP or bPP layer can be suitably used. In the heat-fusible layer 3 formed of this three-layer co-extruded CPP film, the intermediate hPP or bPP layer serves as the intermediate layer 32, the rPP layer on one surface serves as the seal layer 31, and the rPP layer on the other surface serves as the outer layer 33.

In this embodiment, the overall thickness of the heat-fusible layer 3 is preferably set to 20 μm to 120 μm. The thickness of the seal layer 31 is preferably set to 5 μm or more, more preferably to 10 μm or more, and even more preferably to 20 μm or more. That is, when the thickness of the seal layer 31 is specified within this range, the mixed particles, which will be described later, contained in the seal layer 31 can be reliably retained in a stable manner, thereby reliably preventing problems such as detachment of the mixed particles.

In this embodiment, the seal layer 31 contains, as mixed particles, three types of immiscible particles, M1 to M3, that have no mutual compatibility.

As the mixed particles M1 to M3, metal oxides, resin beads, or similar materials can be used. Examples of suitable particles include silica, alumina, calcium carbonate, barium carbonate, titanium dioxide, aluminum silicate, talc, kaolin, acrylic resin beads, polyethylene resin beads, and polyethylene elastomer. It is preferable that the composition of the particles M1 to M3 be such that the mixed particles are formed by combining two or more types of the above particles. By using two or more types of particles having different compositions, aggregation of the mixed particles due to van der Waals forces is less likely to occur, and the mixed particles can be dispersed in the seal layer 31 to form an appropriate surface irregularity.

The content of the mixed particles M1 to M3 in the seal layer 31 is preferably set to 3,000 ppm to 20,000 ppm on a weight basis, and more preferably to 7,000 ppm to 18,000 ppm. That is, when the content of the mixed particles M1 to M3 is set within this range, the mixed particles M1 to M3 can be appropriately dispersed and arranged in a well-balanced manner in the seal layer 31, thereby forming desired surface irregularities on the inner surface of the heat-fusible layer 3.

In this embodiment, the mixed particles (immiscible particles) contained in the seal layer 31 are formed of three types of particles having different volume-based median particle diameters (D50, i.e., the median diameter) in cumulative distribution, that is, small particles M1, medium particles M2, and large particles M3.

The seal layer 31 containing small particles M1, medium particles M2, and large particles M3 having different sizes is arranged so that a part of each of the particles M1 to M3 protrudes inward (downward in FIGS. 1 and 2) from the inner surface of a resin component such as rPP, thereby forming surface irregularities on the inner side of the seal layer 31.

As the small particles M1, particles having a volume-based median particle diameter (D50) of 0.05 μm to 5 μm are preferably used, and more preferably, particles having a volume-based median particle diameter of 0.5 μm to 3 μm are used.

As the medium particles M2, particles having a volume-based median particle diameter (D50) of 3 μm to 8 μm are preferably used, and more preferably, particles having a volume-based median particle diameter of 4 μm to 7 μm are used.

As the large particles M3, particles having a volume-based median particle diameter (D50) of 7 μm to 15 μm are preferably used, and more preferably, particles having a volume-based median particle diameter of 8 μm to 13 μm are used.

In this embodiment, since the seal layer 31 contains three types of particles M1 to M3 having different volume-based median particle diameters (D50), the small particles M1 and the large particles M3 serve to broaden the particle size distribution, and the medium particles M2 serve to unify them into a single distribution. This allows the particles of each size to be uniformly dispersed throughout the seal layer, thereby contributing to the formation of protrusions of various sizes in a well-balanced manner. As a result, when forming the packaging material 1, the contact area with a molding die such as a forming jig can be reduced, thereby improving the sliding properties, which in turn results in stable and excellent formability.

When, instead of particles of different sizes, particles of the same size are mixed, the protrusions become uniform in size, resulting in a monotonous surface shape, which may lead to a decrease in the sliding properties and formability, and may cause embossing marks on the packaging material 1.

In this embodiment, the small particles M1 can form minute surface irregularities on the surface (inner surface) of the heat-fusible layer 3, thereby suppressing close adhesion to the molding die when forming the packaging material 1.

The large particles M3 can reliably form protrusions on the inner surface of the heat-fusible layer 3, thereby reducing dynamic friction with the molding die when forming the packaging material 1.

In addition, the medium particles M2 can form small protrusions on the inner surface of the heat-fusible layer 3 and prevent uneven distribution of the protrusions, thereby further enhancing the effects of the small particles M1 and the large particles M3.

In this embodiment, by specifying the volume-based median particle diameters (D50) of the respective particles M1 to M3 within the above-mentioned ranges, it becomes easier to blend mixed particles having a desired particle size distribution, thereby enabling the intended surface irregularities to be formed on the inner surface of the heat-fusible layer 3. As a result, the contact area with the molding die during forming of the packaging material 1 can be further reduced, thereby further improving the formability of the packaging material 1.

Furthermore, in this embodiment, by specifying the content of the mixed particles within the above-mentioned range or by specifying the thickness of the seal layer 31 within the above-mentioned range, detachment of the particles from the seal layer 31 can be prevented. As a result, the effects of the protrusions can be fully exerted. Consequently, good formability can be more reliably achieved.

In this embodiment, the mixing ratio (weight ratio) of the large particles M3, the medium particles M2, and the small particles M1 is preferably adjusted to 0.5-1.5:1-3:0.5-1.5, and more preferably to 0.8-1.2:1.5-2.5:0.8-1.2. That is, by adjusting the mixing ratio within this range, the above-mentioned effects of the combination of the particles M1 to M3 can be ensured more reliably.

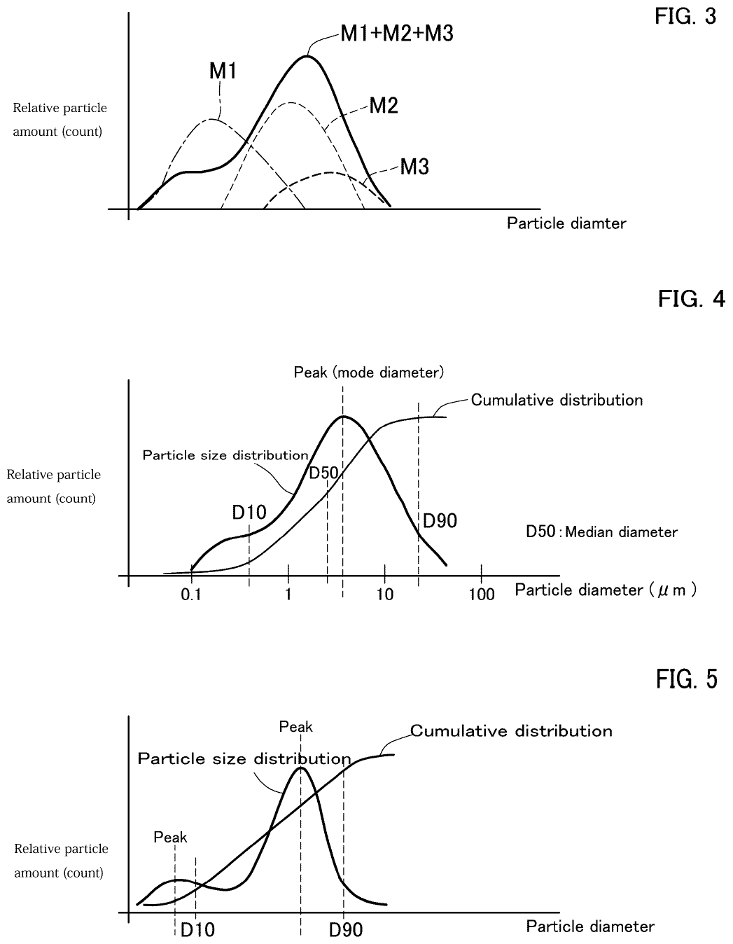

FIG. 3 is a graph showing the individual particle size distributions of the small particles M1, the medium particles M2, and the large particles M3, as well as the particle size distribution of the mixed particles obtained by mixing the small particles M1, the medium particles M2, and the large particles M3. As shown in FIG. 3, since the small particles M1 and the medium particles M2 have smaller particle diameters than the large particles M3, when they are mixed in the same mixing amount (by weight or by volume) as the large particles M3, the particle amount (particle count), which is the presence amount in the particle size distribution, becomes larger.

In the present disclosure, the measurement of the particle size distribution and the cumulative distribution is performed based on the laser diffraction method (laser diffraction scattering method).

In this embodiment, an example has been described in which three types of particles M1 to M3 having different volume-based median particle diameters (D50) are used as mixed particles. However, the present disclosure is not limited thereto, and as long as the mixed particles satisfy the conditions in the particle size distribution, it is sufficient in the present disclosure to use at least two types of particles having different volume-based median particle diameters (D50) as the mixed particles. For example, the mixed particles may be composed of two types, such as the small particles M1 and the medium particles M2, or the small particles M1 and the large particles M3. Furthermore, the mixed particles may be formed using four or more types of particles having different volume-based median particle diameters (D50).

FIG. 4 is a graph showing the particle size distribution and the cumulative distribution of the mixed particles in this embodiment. As shown in FIG. 4, in the particle size distribution of the mixed particles, only one peak appears within the range from the 10% particle diameter (D10) to the 90% particle diameter (D90) in the cumulative distribution, counted from the smaller particle diameter side, and no two or more peaks exist within that range.

Here, in the present disclosure, the particle size distribution of the mixed particles includes only one peak within the range of D10 to D90, and even if a peak exists outside the range of D10 to D90, such a peak is irrelevant to the present disclosure. For example, in the particle size distribution shown in FIG. 5, a peak exists at a position below D10, but this peak is not counted in the present disclosure. That is, the particle size distribution in FIG. 5 includes only one peak within the range of D10 to D90, and thus falls within the scope of the present disclosure.

In this embodiment, in the cumulative distribution of the mixed particles, the particle diameter at D10 is 2 μm or less, and the particle diameter at D90 is 6 μm or more. Furthermore, in this embodiment, the mode diameter as the peak value in the particle size distribution of the mixed particles is 1 μm to 10 μm.

In this embodiment, since the particle diameters at D10 and D90 and the mode diameter are specified to the above-mentioned values, the mixed particles as a whole can have a single broad distribution that is not sharp, and the protrusions formed by the particles M1 to M3 can be uniformly dispersed and formed without unevenness on the inner surface of the heat-fusible layer 3. As a result, during forming of the packaging material 1, stress concentration on the molding die is less likely to occur, thereby improving sliding properties, which in turn further enhances formability.

In this embodiment, it is preferable that the relationship (D90-D10)/D50=0.5 to 5 be satisfied, and more preferably that the relationship (D90-D10)/D50=1.5 to 3 be satisfied. That is, when this relationship is satisfied, the overall volume distribution of the mixed particles can be more reliably made into a broad distribution, thereby allowing various sizes of irregularities to be provided, which further improves the formability during forming of the packaging material 1.

In this embodiment, it is preferable to use, as the respective particles M1 to M3 constituting the mixed particles, those having an aspect ratio (minor axis/major axis) of 0.2 to 1. That is, in this case, since the particles form a certain lump-like shape, the particles M1 to M3 can form protrusions sufficiently regardless of their orientation, and detachment is less likely to occur, which more assuredly improves the formability during forming of the packaging material 1.

In this embodiment, the seal layer 31 of the heat-fusible layer 3 preferably contains a lubricant.

As the lubricant, examples include saturated fatty acid amides, unsaturated fatty acid amides, substituted amides, methylol amides, saturated fatty acid bisamides, unsaturated fatty acid bisamides, fatty acid ester amides, and aromatic bisamides.

More specifically, examples of the saturated fatty acid amides include lauric acid amide, palmitic acid amide, stearic acid amide, behenic acid amide, and hydroxystearic acid amide.

Further, examples of unsaturated fatty acid amides include oleic acid amide and erucic acid amide.

Further, examples of substituted amides include N-oleylpalmitic acid amide, N-stearylstearic acid amide, N-stearyloleic acid amide, N-oleylstearic acid amide, and N-stearylerucic acid amide.

Further, examples of methylol amides include methylolstearic acid amide.

Further, examples of saturated fatty acid bisamides include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenebisbehenic acid amide, hexamethylenehydroxystearic acid amide, N,N′-distearyladipic acid amide, and N,N′-distearylsebacic acid amide.

Further, examples of unsaturated fatty acid bisamides include ethylenebisoleic acid amide, ethylenebiserucic acid amide, hexamethylenebisoleic acid amide, N,N′-dioleyladipic acid amide, and N,N′-dioleylsebacic acid amide.

Further, examples of fatty acid ester amides include stearamidoethyl stearate.

Examples of aromatic bisamides include m-xylylenebisstearic acid amide, m-xylylenebishydroxystearic acid amide, and N,N′-distearylisophthalic acid amide.

It is preferable that the amount of lubricant deposition on the inner surface of the heat-fusible layer 3 be adjusted in the range of 0.1 μg/cm² to 1 μg/cm² (including 0.1 μg/cm² and 1 μg/cm²). If the amount of lubricant deposition is too small, favorable sliding properties cannot be obtained, which is undesirable. Conversely, if the amount of lubricant deposition is too large, the frequency of occurrences such as white powder generation or equipment contamination caused by the lubricant may increase, which is undesirable.

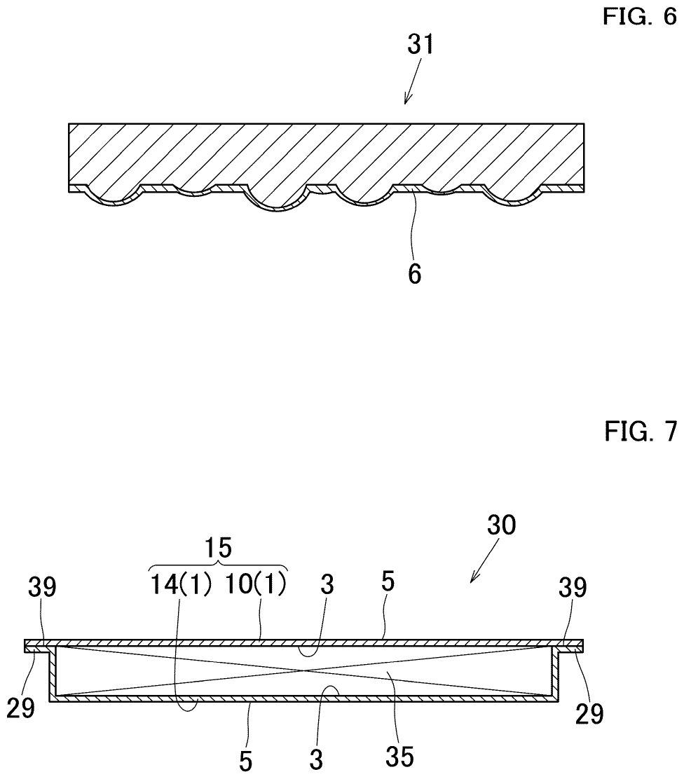

As shown in FIG. 6, since the inner surface of the heat-fusible layer 3 is formed with an uneven structure by the particles M1 to M3, excessive lubricant deposition on the inner surface of the heat-fusible layer 3 can be suppressed. When the temperature reaches a predetermined level or higher, an appropriate amount of lubricant deposition occurs, and the inner surface of the heat-fusible layer 3 is covered with a lubricant layer 6 formed by the lubricant, thereby further improving sliding properties with respect to the forming jig.

When the packaging material 1 of this embodiment is, for example, wound into a roll, the heat-fusible layer 3 comes into contact with the outermost layer such as the base layer 2. As a result, the protrusions formed by the respective particles M1 to M3 preferentially come into contact with other portions (such as the base layer 2), thereby suppressing the amount of lubricant transfer to the other portions.

In the present disclosure, in order to further improve sliding properties during forming, a base material protective layer formed of a binder resin containing small particles may be provided on the outer side of the base layer 2. As the small particles, immiscible particles used as the mixed particles in this embodiment can be used, and as the binder resin, urethane resin, acrylic resin, acrylic urethane resin, fluororesin, and the like can be used.

The exterior packaging material 1 for power storage devices according to this embodiment, which is configured as described above, may be used in sheet form, or, as necessary, may be formed into a predetermined shape by thermoforming such as deep drawing or stretch forming, and is used as a packaging case for power storage devices.

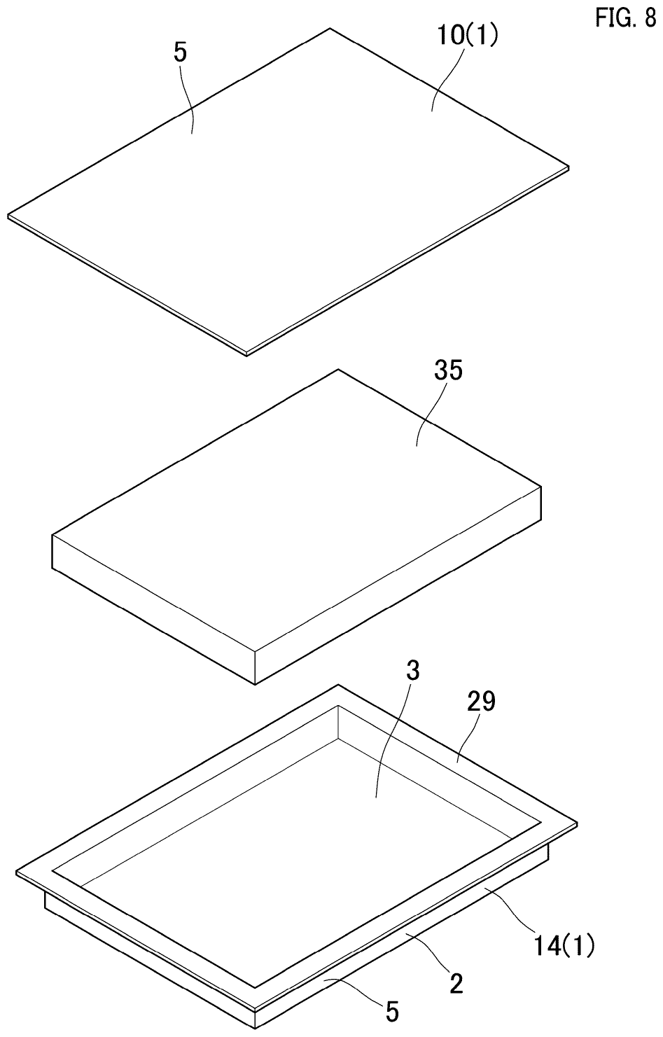

For example, FIGS. 7 and 8 are a cross-sectional view and an exploded perspective view, respectively, showing a power storage device 30 manufactured using the packaging material 1 of this embodiment. As shown in both figures, the power storage device 30 is a lithium-ion secondary battery. In this embodiment, a packaging case 15 is constituted by a tray member 14 obtained by forming the packaging material 1 and a lid member 10 constituted by a flat (sheet form) of the packaging material 1.

Specifically, a substantially rectangular parallelepiped power storage device main body (electrochemical element or the like) 35 is accommodated in a housing recess of the tray member 14 obtained by forming the packaging material 1 of the present disclosure, and the lid member 10 (packaging material 1) of the present disclosure is disposed over the power storage device main body 35 with the heat-fusible layer 3 side facing inward (downward). The peripheral edge portion of the heat-fusible layer 3 of the lid member 10 and the heat-fusible layer 3 of the flange portion (sealing peripheral portion) 29 of the tray member 14 are sealed together by heat sealing, thereby forming the power storage device 30.

Note that the inner surface of the housing recess of the tray member 14 is the heat-fusible layer 3, and the outer surface of the housing recess is the base layer 2 side.

In FIG. 7, the reference numeral “39” denotes a heat seal portion at which the outer peripheral edge portion of the lid member 10 and the flange portion (sealing peripheral portion) 29 of the tray member 14 are joined (welded). In the power storage device 30, the tip end portion of a tab lead connected to the power storage device main body 35 is drawn out to the outside of the packaging case 15, but illustration thereof is omitted.

The power storage device 30 manufactured using the packaging material 1 of this embodiment includes the packaging material 1 that exhibits excellent sliding properties with respect to a molding die and has high adhesion strength between the heat-fusible layer 3 and the adhesive layer 5. As a result, it is possible to reliably supply a highly reliable, high-quality power storage device.

The power storage device main body 35 is not particularly limited, and examples thereof include a battery cell, a capacitor cell, and a condenser cell.

In the above embodiment, the packaging case 15 is constituted by the tray member 14 obtained by forming the packaging material 1 and the flat lid member 10. However, the present disclosure is not particularly limited to such a combination. For example, the packaging case 15 may be constituted by a pair of flat (sheet-like) packaging materials 1 or may be constituted by superposing a pair of tray members 14 with their inner surfaces facing each other.

### EXAMPLE

TABLE 1

| | Seal layer (innermost layer) | | | | | | | | | |
|---|---|---|---|---|---|---|---|---|---|---|
| | Small particles | | | Medium particles | | | Large particles | | | |
| | | Median | | | Median | | | Median | | |
| | | particle | | | particle | | | particle | | Content |
| | | diameter | Content | | diameter | Content | | diameter | Content | (Total |
| | Particle | (μm) | (ppm) | Particle | (μm) | (ppm) | Particle | (μm) | (ppm) | amount) |
| Ex. 1 | Silica | 1.5 | 3000 | Silica | 6 | 6000 | HDPE beads | 12 | 3000 | 12000 |
| Ex. 2 | Silica | 2 | 3000 | Barium sulfate | 8 | 6000 | HDPE beads | 19 | 3000 | 12000 |
| Ex. 3 | Titanium dioxide | 0.1 | 3000 | Silica | 4 | 6000 | LLDPE beads | 7 | 3000 | 12000 |
| Ex. 4 | Silica | 0.5 | 3000 | Silica | 7 | 6000 | LLDPE beads | 16 | 3000 | 12000 |
| Ex. 5 | Titanium dioxide | 0.1 | 4000 | Titanium dioxide | 3 | 8000 | HDPE beads | 12 | 2000 | 14000 |
| Ex. 6 | Silica | 2 | 3000 | Alumina | 6 | 6000 | HDPE beads | 12 | 3000 | 12000 |
| Ex. 7 | Silica | 2 | 3000 | Silica | 6 | 6000 | Silica | 15 | 3000 | 12000 |
| Ex. 8 | Titanium dioxide | 0.06 | 10000 | Silica | 3 | 6000 | LLDPE beads | 10 | 2000 | 18000 |
| Ex. 9 | Silica | 4.5 | 6000 | Silica | 8 | 6000 | HDPE beads | 18 | 6000 | 18000 |
| Ex. 10 | Silica | 1.5 | 6000 | Silica | 6 | 10000 | HDPE beads | 12 | 6000 | 22000 |
| Ex. 11 | Silica | 1.5 | 7000 | Silica | 6 | 8000 | HDPE beads | 12 | 4000 | 19000 |
| Ex. 12 | Silica | 1.5 | 1500 | Silica | 6 | 3000 | HDPE beads | 12 | 500 | 5000 |
| Ex. 13 | Silica | 1.5 | 600 | Silica | 6 | 1400 | HDPE beads | 12 | 700 | 2700 |
| Ex. 14 | Silica | 1.5 | 800 | Silica | 6 | 1500 | HDPE beads | 12 | 800 | 3100 |
| Ex. 15 | Silica | 1.5 | 3000 | Silica | 6 | 6000 | HDPE beads | 12 | 3000 | 12000 |
| Ex. 16 | Silica | 1.5 | 3000 | Silica | 6 | 6000 | HDPE beads | 12 | 3000 | 12000 |
| Ex. 17 | Silica | 1.5 | 3000 | Silica | 6 | 6000 | HDPE beads | 12 | 3000 | 12000 |
| Ex. 18 | Silica | 1.5 | 3000 | Silica | 6 | 6000 | HDPE beads | 12 | 3000 | 12000 |
| Ex. 19 | Silica | 1.5 | 3000 | Silica | 6 | 6000 | HDPE beads | 12 | 3000 | 12000 |
| Comp. Ex. 1 | Silica | 1.5 | 6000 | — | — | — | HDPE beads | 12 | 4000 | 10000 |
| Comp. Ex. 2 | Silica | 2 | 2000 | Silica | 7 | 8000 | HDPE beads | 18 | 6000 | 16000 |
| Comp. Ex. 3 | Titanium dioxide | 0.08 | 10000 | Silica | 3 | 4000 | Silica | 7 | 1000 | 15000 |
| Comp. Ex. 4 | Silica | 1.5 | 200 | Silica | 3 | 12000 | HDPE beads | 5 | 200 | 12400 |

TABLE 2

| | | | | | | | | | | | Outer layer |
|---|---|---|---|---|---|---|---|---|---|---|---|
| | Seal layer (innermost layer) | | | | | | | | | Intermediate | (Metal foil |
| | Mixed particles | | | | | | | | | layer | side layer) |
| | | | | (d90 − | Aspect | Peak | Peak | Base | Layer | Resin (layer | Resin (layer |
| | d10 | d50 | d90 | d10)/d50 | ratio | count | position | resin | thickness | thickness) | thickness) |
| Ex. 1 | 0.8 | 3.8 | 8.2 | 1.9 | 0.8 | 1 | 4.1 | rPP | 16 | bPP(48) | rPP(16) |
| Ex. 2 | 1.9 | 5.6 | 12.7 | 1.9 | 0.7 | 1 | 6.6 | rPP | 16 | bPP(48) | rPP(16) |
| Ex. 3 | 0.5 | 2.4 | 6.5 | 2.5 | 0.9 | 1 | 2.7 | rPP | 16 | bPP(48) | rPP(16) |
| Ex. 4 | 1.1 | 5.6 | 10.5 | 1.7 | 0.6 | 1 | 7.1 | rPP | 16 | bPP(48) | rPP(16) |
| Ex. 5 | 0.3 | 1.8 | 8.7 | 4.7 | 0.9 | 1 | 3.6 | rPP | 16 | bPP(48) | rPP(16) |
| Ex. 6 | 1.6 | 4.8 | 9.7 | 1.7 | 0.4 | 1 | 6.1 | rPP | 16 | bPP(48) | rPP(16) |
| Ex. 7 | 1.2 | 5.6 | 12.1 | 1.9 | 0.2 | 1 | 7.5 | rPP | 16 | bPP(48) | rPP(16) |
| Ex. 8 | 0.1 | 0.9 | 6.2 | 6.8 | 0.9 | 1 | 1.1 | rPP | 16 | bPP(48) | rPP(16) |
| Ex. 9 | 1.9 | 8.2 | 13.2 | 1.4 | 0.6 | 1 | 9.7 | rPP | 16 | bPP(48) | rPP(16) |
| Ex. 10 | 0.7 | 3.6 | 8.4 | 2.1 | 0.8 | 1 | 4.3 | rPP | 16 | bPP(48) | rPP(16) |
| Ex. 11 | 0.7 | 3.4 | 7.9 | 2.1 | 0.8 | 1 | 3.7 | rPP | 16 | bPP(48) | rPP(16) |
| Ex. 12 | 0.5 | 3.2 | 7.2 | 2.1 | 0.8 | 1 | 3.7 | rPP | 16 | bPP(48) | rPP(16) |
| Ex. 13 | 0.8 | 4.3 | 8.2 | 1.7 | 0.8 | 1 | 4.7 | rPP | 16 | bPP(48) | rPP(16) |
| Ex. 14 | 0.8 | 3.6 | 8.1 | 2.0 | 0.8 | 1 | 3.9 | rPP | 16 | bPP(48) | rPP(16) |
| Ex. 15 | 0.8 | 3.8 | 8.2 | 1.9 | 0.8 | 1 | 4.1 | rPP | 8 | bPP(24) | rPP(8) |
| Ex. 16 | 0.8 | 3.8 | 8.2 | 1.9 | 0.8 | 1 | 4.1 | rPP | 4 | bPP(32) | rPP(4) |
| Ex. 17 | 0.8 | 3.8 | 8.2 | 1.9 | 0.8 | 1 | 4.1 | rPP | 5 | bPP(30) | rPP(5) |
| Ex. 18 | 0.8 | 3.8 | 8.2 | 1.9 | 0.8 | 1 | 4.1 | rPP | 80 | — | — |
| Ex. 19 | 0.8 | 3.8 | 8.2 | 1.9 | 0.8 | 1 | 4.1 | rPP | 40 | — | — |
| Comp. Ex. 1 | 0.5 | 4.1 | 10.8 | 2.5 | 0.8 | 2 | 1.9/9.3 | rPP | 16 | bPP(48) | rPP(16) |
| Comp. Ex. 2 | 3.5 | 9.1 | 16.7 | 1.5 | 0.8 | 1 | 11 | rPP | 16 | bPP(48) | rPP(16) |
| Comp. Ex. 3 | 0.1 | 0.7 | 2.1 | 2.9 | 0.8 | 1 | 0.9 | rPP | 16 | bPP(48) | rPP(16) |
| Comp. Ex. 4 | 2.1 | 3.1 | 4.1 | 0.6 | 0.8 | 1 | 3.2 | rPP | 16 | bPP(48) | rPP(16) |

### 1. Production of Film for Heat-Fusible Layer

### Example 1

As shown in Table 1 and Table 2, a film for the heat-fusible layer 3 in the packaging material 1 for power storage devices in Example 1 was produced. Specifically, as the film for the heat-fusible layer 3, a CPP film was produced by three-layer co-extrusion using a T-die, in which 16 μm-thick rPP for the seal layer, 48 μm-thick bPP for the intermediate layer, and 16 μm-thick rPP for the outer layer were laminated.

In the film for the heat-fusible layer of Example 1, 3,000 ppm of silica particles having a volume-based median particle diameter of 1.5 μm were added as small particles M1, 6,000 ppm of silica particles having a volume-based median particle diameter of 6 μm were added as medium particles M2, and 3,000 ppm of HDPE (high-density polyethylene) particles having a volume-based median particle diameter of 12 μm were added as large particles M3 to the seal layer 31.

As shown in Table 2, in the mixed particles M1 to M3 added to the seal layer 31, the 10% particle diameter (D10) was 0.8 μm, the 50% particle diameter (D50) was 3.8 μm, the 90% particle diameter (D90) was 8.2 μm, (D90−D10)/D50 was 1.9, the aspect ratio was 0.8, the number of peaks within the range of D10 to D90 of the volume distribution was one, and the peak position was 4.1 μm.

The particle size distribution of the mixed particles was measured using a laser diffraction method. Specifically, a Microtrac MT3000II was used as the measurement device. The measurement range under the measurement conditions was 0.02 μm to 2,000 μm, the measurement time was 30 seconds, the number of measurements was two, the solvent was methanol (refractive index: 1.33), and the particle setting condition was non-spherical particles (refractive index: 1.54).

The aspect ratio of each particle was measured using an FPIA-3000 manufactured by Sysmex Corporation.

### Examples 2 to 17

Films for the heat-fusible layer in Examples 2 to 17 were produced by laminating the seal layer resin, the intermediate layer resin, and the outer layer resin shown in Tables 1 and 2 in the same manner as in Example 1.

### Examples 18 and 19

Using the seal layer resins shown in Tables 1 and 2, single-layer unstretched films were produced by a T-die, and were used as the heat-fusible films in Examples 18 and 19.

### Comparative Examples 1 to 4

Heat-fusible layer films were produced by laminating the seal layer resin, the intermediate layer resin, and the outer layer resin shown in Tables 1 and 2 in the same manner as in Example 1. In the mixed particles of Comparative Example 1, the number of peaks within the range of D10 to D90 of the volume distribution was two, and the respective peak positions were 1.9 μm and 9.3 μm.

### 2. Production of Packaging Material for Power Storage Device

A chemical conversion coating was formed by applying, to both surfaces of an aluminum foil (A8021-O) having a thickness of 40 μm used as the metal foil layer 4, a chemical treatment solution composed of phosphoric acid, polyacrylic acid (acrylic resin), a chromium (III) chloride compound, water, and alcohol, and then drying at 180° C. The amount of chromium adhered in the chemical conversion coating was 10 mg/m² per side.

Next, a 15 μm-thick biaxially stretched 6-nylon (ONy) film was dry-laminated (bonded), as the base layer 2, to one surface (outer surface) of the above chemically treated aluminum foil (metal foil layer 4) via a 3 μm-thick two-component curable urethane adhesive.

Next, the outer surface of the outer layer of the CPP film for the heat-fusible layer prepared in the above Examples and Comparative Examples was overlaid on the other surface (inner surface) of the aluminum foil (metal foil layer) after dry lamination, via a 2 μm-thick two-component curable adhesive composed of maleic acid-modified polypropylene resin and isocyanate. The layers were then dry-laminated by pressing them between a rubber nip roll and a laminating roll heated to 100° C. Thereafter, aging was performed at 40° C. for 10 days to obtain the exterior materials (laminates) of the Examples and Comparative Examples as test samples.

### 3. Evaluation Tests for Each Packaging Material

TABLE 3

| | | | Sliding properties |
|---|---|---|---|
| | | | (Dynamic friction |
| | Formability | Sealability | coefficient) |
| Ex. 1 | [symbol] | [symbol] | 0.1 |
| Ex. 2 | [symbol] | [symbol] | 0.1 |
| Ex. 3 | ◯ | [symbol] | 0.2 |
| Ex. 4 | [symbol] | [symbol] | 0.2 |
| Ex. 5 | ◯ | [symbol] | 0.1 |
| Ex. 6 | ◯ | [symbol] | 0.3 |
| Ex. 7 | Δ | [symbol] | 0.4 |
| Ex. 8 | Δ | ◯ | 0.2 |
| Ex. 9 | [symbol] | ◯ | 0.2 |
| Ex. 10 | [symbol] | Δ | 0.2 |
| Ex. 11 | ◯ | ◯ | 0.2 |
| Ex. 12 | ◯ | [symbol] | 0.3 |
| Ex. 13 | Δ | [symbol] | 0.4 |
| Ex. 14 | [symbol] | [symbol] | 0.2 |
| Ex. 15 | [symbol] | ◯ | 0.1 |
| Ex. 16 | [symbol] | Δ | 0.1 |
| Ex. 17 | [symbol] | ◯ | 0.1 |
| Ex. 18 | [symbol] | [symbol] | 0.2 |
| Ex. 19 | [symbol] | [symbol] | 0.1 |
| Comp. Ex. 1 | X | [symbol] | 0.6 |
| Comp. Ex. 2 | [symbol] | X | 0.1 |
| Comp. Ex. 3 | X | [symbol] | 0.8 |
| Comp. Ex. 4 | X | [symbol] | 1.1 |

### <Formability Test>

For each packaging material of Examples and Comparative Examples, a deep-drawing test was conducted on a packaging material test piece cut to a predetermined size, using a deep-drawing molding die. The test was carried out by increasing the forming height (drawing depth) in increments of 0.5 mm within a range of 55 mm (length)×35 mm (width). The gauge pressure of the blank holder during forming was 0.475 MPa, and the actual pressure (calculated value) was 0.7 MPa.

Using transmitted light, it was visually confirmed whether or not pinholes were generated at the corner portions of the drawn recess as a result of the forming.

Evaluation was conducted as follows: when pinhole generation was observed at a forming depth of 7 mm or more, it was rated as “ [symbol] ”; when observed at a forming depth of 6 mm or more but less than 7 mm, it was rated as “∘”; when observed at a forming depth of 5 mm or more but less than 6 mm, it was rated as “Δ”; and when observed at a forming depth of less than 5 mm, it was rated as “×”. In this evaluation, “ [symbol] ”, “∘”, and “Δ” were regarded as passes (acceptable) in this embodiment. The results are shown in Table 3.

### <Adhesion Strength (Sealability) Test>

Each packaging material from Examples and Comparative Examples was cut into strips having a width of 15 mm, and the peel strength between the metal foil layer and the heat-fusible layer was measured in accordance with JIS K 6854-3 (1999). Evaluation was as follows: a peel strength of 4.0 N/15 mm or more was rated as “ [symbol] ”; 3.0 N/15 mm or more and less than 4.0 N/15 mm was rated as “∘”; 2.0 N/15 mm or more and less than 3.0 N/15 mm was rated as “Δ”; and less than 2.0 N/15 mm was rated as “×”. In this evaluation, “ [symbol] ”, “∘”, and “Δ” were regarded as passes (acceptable) in this embodiment. The results are shown in Table 3.

### <Sliding Property Test (Dynamic Friction Coefficient)>

Each packaging material of Examples and Comparative Examples was cut to a size of 80 mm×200 mm, and the dynamic friction coefficient was measured in accordance with JIS K 7125. As measurement conditions, the load cell weight was 100 N, and the weight was 200 g (including the sliding block weight). The results of the dynamic friction coefficient are shown in Table 3.

### Overall Evaluation

As shown in Table 3, although some variation was observed in the results for the packaging materials of Examples, all of the packaging materials of Examples obtained satisfactory results and met the acceptable standard.

In contrast, the packaging materials of Comparative Examples 1 to 4, which fall outside the scope of the present disclosure, showed inferior performance in at least one evaluation item: formability, sealability, or sliding properties.

The present application claims priority from Japanese Patent Application No. 2023-067332 filed on Apr. 17, 2023, the disclosure of which is incorporated herein by reference in its entirety.

The terms and expressions used herein are for purposes of description and are not intended to be limiting. It should be understood that equivalents of any of the features disclosed and illustrated herein are encompassed, and that various modifications within the scope of the above-described claimed invention are allowable.

While the present disclosure may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the present disclosure may be embodied in many different forms, a number of illustrative embodiments have been described herein. The present disclosure is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### INDUSTRIAL APPLICABILITY

The packaging material for power storage devices according to the present invention is suitably applicable to the manufacture of power storage devices, including batteries and capacitors for mobile devices such as smartphones and tablets, and batteries and capacitors for power storage in hybrid vehicles, electric vehicles, wind power generation, solar power generation, and for storing off-peak electricity such as that generated at night.

### DESCRIPTION OF REFERENCE SYMBOLS

1: packaging material
2: base layer
3: heat-fusible layer
30: power storage device
31: seal layer
35: power storage device main body
4: metal foil layer
6: lubricant layer
M1: small particle
M2: medium particle
M3: large particle

1. A packaging material for power storage devices, the packaging material comprising:
a metal foil layer having an outer surface side and an inner surface side opposite to the outer surface side;
a base layer made of resin and provided on the outer surface side of the metal foil layer; and
a heat-fusible layer made of thermoplastic resin and provided on the inner surface side of the metal foil layer, the heat-fusible layer comprising: a seal layer provided to form an innermost side of the packaging material, the seal layer including mixed particles of two or more types of particles having different volume-based median particle diameters, defined as D50, which is a particle diameter at 50% of a cumulative distribution in a particle size distribution measurement by a laser diffraction scattering method,
wherein, in the cumulative distribution of the mixed particles, D10, which is a particle diameter at 10% of the cumulative distribution counted from a smaller particle diameter side, is 2 μm or less, and D90, which is a particle diameter at 90% of the cumulative distribution counted from a smaller particle diameter side, is 6 μm or more,
wherein in a particle size distribution of the mixed particles, only one peak is present within a range of D10 to D90, and
wherein a peak value in the particle size distribution of the mixed particles is present in a particle diameter range of 1 μm to 10 μm.

2. The packaging material for power storage devices as recited in claim 1,
wherein the mixed particles include small particles, medium particles, and large particles, which are immiscible particles belonging to three distributions having different volume-based median particle diameters,
wherein the small particles have a volume-based median particle diameter of 0.05 μm to 5 μm,
wherein the medium particles have a volume-based median particle diameter of 3 μm to 8 μm, and
wherein the large particles have a volume-based median particle diameter of 7 μm to 15 μm.

3. The packaging material for power storage devices as recited in claim 1,
wherein the seal layer has a content of the mixed particles by weight in a range of 3,000 ppm to 20,000 ppm.

4. The packaging material for power storage devices as recited in claim 1,
wherein the seal layer has a thickness of 5 μm or more.

5. The packaging material for power storage devices as recited in claim 1,
wherein the mixed particles have an aspect ratio of 0.2 to 1.

6. The packaging material for power storage devices as recited in claim 1,
wherein the seal layer contains a lubricant.

7. The packaging material for power storage devices as recited in claim 1,
wherein a relational expression (D90−D10)/D50=0.5 to 5 is satisfied.

8. A film used for the heat-fusible layer in the packaging material for power storage devices as recited in claim 1,
wherein a portion corresponding to the seal layer is composed of a resin layer containing the mixed particles.

9. A method for manufacturing a film used for the heat-fusible layer in the packaging material for power storage devices as recited in claim 1,
wherein a portion corresponding to the seal layer is formed of a resin layer blended with the mixed particles.

10. A power storage device comprising:
a power storage device main body; and
the packaging material for power storage devices as recited in claim 1,
wherein the power storage device main body is enclosed with the packaging material.
